(19) United States
(12) Patent Application Publication
(10) Pub. No.: US 2026/0111341 A1
(43) Pub. Date: Apr. 23, 2026

(54) METHOD AND SYSTEM FOR ENHANCING CODE CONSISTENCY AND FRAMEWORK ADHERENCE IN SOFTWARE DEVELOPMENT

(71) Applicant: JPMorgan Chase Bank, N.A., New York, NY (US)

(72) Inventors: Rakesh Singh MOIRANGTHEM, Frisco, TX (US); Ninad GAWAD, Jersey City, NJ (US); Shubhashis DASGUPTA, Edison, NJ (US)

(73) Assignee: JPMorgan Chase Bank, N.A., New York, NY (US)

(21) Appl. No.: 19/365,774

(22) Filed: Oct. 22, 2025

Related U.S. Application Data
(60) Provisional application No. 63/710,978, filed on Oct. 23, 2024.

(51) Int. Cl. G06F 11/3604

(52) U.S. Cl. CPC G06F 11/3608

(57) ABSTRACT

Various methods and processes, apparatuses or systems, and media for analyzing new software code submissions in large-scale projects for adherence to an existing codebase and compliance with project-specific frameworks and coding standards are disclosed. The method includes: receiving a first set of software code that is intended for an integration into a framework that includes existing sets of code; generating an embedding of the first set of software code; comparing the first embedding with a respective embedding of each respective one of the existing sets of software code, and determining a respective degree of similarity between the first embedding and each respective embedding; quantifying a degree of deviation between the first set of software code and the framework; and generating a framework deviation analysis report that includes textual information to describe deviations, issues, and recommendations associated with the integration.

### CROSS-REFERENCE TO RELATED APPLICATION

This application claims the benefit of U.S. Provisional Patent Application No. 63/710,978, filed October 23, 2024, which is hereby incorporated by reference in its entirety.

### TECHNICAL FIELD

This disclosure relates to methods and apparatuses for analyzing new software code submissions in large-scale projects for adherence to an existing codebase and quantifying variations to ensure compliance with project-specific frameworks and coding standards.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Software development often involves an iterative approach by which different ideas and methodologies are tested to achieve the best possible outcomes. However, this may result in non-compliance with established frameworks and guidelines. While conventional tools detect bugs, vulnerabilities and code smells, such tools typically fail to enforce frameworks tailored to individual projects.

Maintaining code consistency and strict adherence to predefined frameworks is crucial for ensuring robust, maintainable and scalable applications. Deviations from established coding frameworks may lead to significant challenges in project management, increased maintenance costs, scalability concerns, and potential integration issues.

In a large software development project involving multiple developers, the testing of various innovative ideas and methodologies to achieve optimal outcomes may sometimes result in non-compliance with project specific established frameworks and guidelines. This situation may be particularly overwhelming for new developers, making it challenging for them to determine which framework to follow.

In addition, conventional techniques for ensuring code consistency and adherence to a predefined framework often require the development of additional software for a purpose of rectifying incompatibilities that may be introduced by a new software code submission, and such additional development typically translates into utilization of system resources.

Accordingly, there is a need for a mechanism for analyzing new software code submissions in large-scale projects for adherence to an existing codebase and quantifying variations to ensure compliance with project-specific frameworks and coding standards.

### SUMMARY

The present disclosure, through one or more of its various aspects, embodiments, and/or specific features or sub-components, provides, among other features, various systems, servers, devices, methods, media, programs, and platforms for analyzing new software code submissions in large-scale projects for adherence to an existing codebase and quantifying variations to ensure compliance with project-specific frameworks and coding standards.

According to an aspect of the present disclosure, a method for integrating software code into an existing codebase is provided. The method may be implemented by at least one processor. The method may include: receiving, from a user, a first set of software code that is intended for an integration into a first framework that includes a plurality of existing sets of software code; generating a first embedding of the first set of software code; comparing the first embedding with a respective embedding of each respective one of the plurality of existing sets of software code, each respective embedding being stored in a vector database; determining, based on a result of the comparing, a respective degree of similarity between the first embedding and each respective embedding; quantifying, based on a result of the determining, a degree of deviation between the first set of software code and the first framework; and generating, based on the result of the determining and a result of the quantifying, a framework deviation analysis report that includes textual information to describe at least one from among a difference, an issue, and a recommendation associated with the integration into the first framework.

The determining of the respective degree of similarity may include using at least one from among a predetermined cosine similarity algorithm and a predetermined Euclidean distance algorithm to calculate a respective similarity score.

The quantifying may include using each respective similarity score to compute a percentage deviation score.

The generating of the framework deviation report may be performed by using a predetermined large language model (LLM) that is configured to: receive the first set of software code, the plurality of existing sets of software code, the respective similarity scores, and the percentage deviation score as inputs; identify semantic differences and syntactic differences between the first set of software code and the plurality of existing sets of software code; detect at least one from among a pattern and an anomaly associated with the first set of software code with respect to the plurality of existing sets of software code; and generate the framework deviation report based on the identified semantic differences, the identified syntactic differences, and the detected at least one from among the pattern and the anomaly.

The framework deviation report may include a first textual item that relates to a status of the first set of software code with respect to the plurality of existing sets of software code, a second textual item that relates to the percentage deviation score, a third textual item that relates to a summary description of how the first set of software code deviates from the plurality of existing sets of software code, a fourth textual item that relates to a project impact to be incurred by the integration of the first set of software code into the first framework, and a fifth textual item that relates to a recommendation for additional action to be taken as a result of the integration.

The project impact may include first information that relates to a potential code refactoring requirement with respect to at least one of the plurality of existing sets of software code, second information that relates to a consistency between the first set of software code and the first framework, and third information that relates to dependency management as between the first set of software code and the first framework.

The difference may include at least one from among a formatting difference between the first set of software code and the first framework, a field character length difference between the first set of software code and the first framework, a field type difference between the first set of software code and the first framework, and a terminological difference between the first set of software code and the first framework.

The issue may include at least one from among a compatibility failure between the first set of software code and the first framework, an error that is generated by the first set of software code as a result of an interaction with the first framework, and an operational failure that renders the first framework at least temporarily inoperable.

The recommendation may include at least one from among a first recommendation to revise the first set of software code in a particular way, a second recommendation to delete a particular portion of the first set of software code, and a third recommendation to insert additional code that relates to a particular inconsistency.

According to another embodiment, a computing apparatus for integrating software code into an existing codebase is provided. The computing apparatus includes a processor; a memory; and a communication interface coupled to each of the processor and the memory. The processor may be configured to: receive, from a user via the communication interface, a first set of software code that is intended for an integration into a first framework that includes a plurality of existing sets of software code; generate a first embedding of the first set of software code; compare the first embedding with a respective embedding of each respective one of the plurality of existing sets of software code, each respective embedding being stored in a vector database; determine, based on a result of the comparison, a respective degree of similarity between the first embedding and each respective embedding; quantify, based on a result of the determination, a degree of deviation between the first set of software code and the first framework; and generate, based on the result of the determination and a result of the quantification, a framework deviation analysis report that includes textual information to describe at least one from among a difference, an issue, and a recommendation associated with the integration into the first framework.

The processor may be further configured to determine the respective degree of similarity by using at least one from among a predetermined cosine similarity algorithm and a predetermined Euclidean distance algorithm to calculate a respective similarity score.

The processor may be further configured to quantify the degree of deviation by using each respective similarity score to compute a percentage deviation score.

The processor may be further configured to generate the framework deviation report by using a predetermined LLM that is configured to: receive the first set of software code, the plurality of existing sets of software code, the respective similarity scores, and the percentage deviation score as inputs; identify semantic differences and syntactic differences between the first set of software code and the plurality of existing sets of software code; detect at least one from among a pattern and an anomaly associated with the first set of software code with respect to the plurality of existing sets of software code; and generate the framework deviation report based on the identified semantic differences, the identified syntactic differences, and the detected at least one from among the pattern and the anomaly.

The framework deviation report may include a first textual item that relates to a status of the first set of software code with respect to the plurality of existing sets of software code, a second textual item that relates to the percentage deviation score, a third textual item that relates to a summary description of how the first set of software code deviates from the plurality of existing sets of software code, a fourth textual item that relates to a project impact to be incurred by the integration of the first set of software code into the first framework, and a fifth textual item that relates to a recommendation for additional action to be taken as a result of the integration.

The project impact may include first information that relates to a potential code refactoring requirement with respect to at least one of the plurality of existing sets of software code, second information that relates to a consistency between the first set of software code and the first framework, and third information that relates to dependency management as between the first set of software code and the first framework.

The difference may include at least one from among a formatting difference between the first set of software code and the first framework, a field character length difference between the first set of software code and the first framework, a field type difference between the first set of software code and the first framework, and a terminological difference between the first set of software code and the first framework.

The issue may include at least one from among a compatibility failure between the first set of software code and the first framework, an error that is generated by the first set of software code as a result of an interaction with the first framework, and an operational failure that renders the first framework at least temporarily inoperable.

The recommendation may include at least one from among a first recommendation to revise the first set of software code in a particular way, a second recommendation to delete a particular portion of the first set of software code, and a third recommendation to insert additional code that relates to a particular inconsistency.

According to yet another embodiment, a non-transitory computer readable storage medium storing instructions for integrating software code into an existing codebase is provided. The storage medium includes a set of executable code which, when executed by a processor, causes the processor to: receive, from a user, a first set of software code that is intended for an integration into a first framework that includes a plurality of existing sets of software code; generate a first embedding of the first set of software code; compare the first embedding with a respective embedding of each respective one of the plurality of existing sets of software code, each respective embedding being stored in a vector database; determine, based on a result of the comparison, a respective degree of similarity between the first embedding and each respective embedding; quantify, based on a result of the determination, a degree of deviation between the first set of software code and the first framework; and generate, based on the result of the determination and a result of the quantification, a framework deviation analysis report that includes textual information to describe at least one from among a difference, an issue, and a recommendation associated with the integration into the first framework.

When executed, the executable code may further cause the processor to determine the respective degree of similarity by using at least one from among a predetermined cosine similarity algorithm and a predetermined Euclidean distance algorithm to calculate a respective similarity score.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for analyzing new software code submissions in large-scale projects for adherence to an existing codebase and quantifying variations to ensure compliance with project-specific frameworks and coding standards, in accordance with an embodiment.

FIG. 2 illustrates an exemplary diagram of a network environment with a device for analyzing new software code submissions in large-scale projects for adherence to an existing codebase and quantifying variations to ensure compliance with project-specific frameworks and coding standards, in accordance with an embodiment.

FIG. 3 illustrates a system diagram for implementing a method for analyzing new software code submissions in large-scale projects for adherence to an existing codebase and quantifying variations to ensure compliance with project-specific frameworks and coding standards, in accordance with an embodiment.

FIG. 4 illustrates an exemplary flow chart of a process for analyzing new software code submissions in large-scale projects for adherence to an existing codebase and quantifying variations to ensure compliance with project-specific frameworks and coding standards, in accordance with an embodiment.

FIG. 5 illustrates a data flow diagram for a system for analyzing new software code submissions in large-scale projects for adherence to an existing codebase and quantifying variations to ensure compliance with project-specific frameworks and coding standards, in accordance with an embodiment.

FIG. 6 illustrates an architecture diagram of a system for analyzing new software code submissions in large-scale projects for adherence to an existing codebase and quantifying variations to ensure compliance with project-specific frameworks and coding standards, in accordance with an embodiment.

FIG. 7 illustrates a system orchestrator diagram that shows a set of functions that are performed in a system for analyzing new software code submissions in large-scale projects for adherence to an existing codebase and quantifying variations to ensure compliance with project-specific frameworks and coding standards, in accordance with an embodiment

FIG. 8 illustrates an example screenshot generated by a system for analyzing new software code submissions in large-scale projects for adherence to an existing codebase and quantifying variations to ensure compliance with project-specific frameworks and coding standards, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

Conventional techniques for ensuring code consistency and adherence to a predefined framework have often required the development of additional software for a purpose of rectifying incompatibilities that may be introduced by a new software code submission, and such additional development has typically translated into utilization of system resources. By contrast, a scalable and intelligent system for analyzing new software code submissions in large-scale projects for adherence to an existing codebase and quantifying variations to ensure compliance with project-specific frameworks and coding standards may reduce unnecessary usage of system resources, such as memory capacity and system throughput, which may otherwise be consumed as a result of additional development required to remedy inconsistencies. In addition, such a system may also improve computer functionality by advantageously leveraging the use of artificial intelligence (AI) models, such as Large Language Models (LLMs) that automate the analysis and efficiently ensure efficiency.

As disclosed herein, a system or method for analyzing new software code submissions in large-scale projects for adherence to an existing codebase and quantifying variations to ensure compliance with project-specific frameworks and coding standards may reduce unnecessary usage of system resources, such as memory capacity and system throughput, which may otherwise be required by search and retrieval processes employed by human specialists, by providing information that relates to similarities between the new code submission and individual modules within the existing codebase, information that relates to a degree of deviation between the new code submission and the existing codebase as a whole, and a report that provides recommendations for addressing such a deviation. In addition, such a system may also improve computer functionality by advantageously leveraging the use of multiple AI models that are independently trained by using data sets that are customized for specific areas of expertise. In particular, the system or method may achieve these improvements by: receiving, from a user, a new set of software code that is intended for an integration into a framework that includes existing sets of software code; generating a first embedding of the new set of software code; comparing the first embedding with a respective embedding of each respective one of the plurality of existing sets of software code, each respective embedding being stored in a vector database; determining, based on a result of the comparison, a respective degree of similarity between the first embedding and each respective embedding; quantifying, based on a result of the determination, a degree of deviation between the new set of software code and the framework; and generating, based on the results of the determination and the quantification, a framework deviation analysis report that includes textual information to describe deviation(s), issue(s), and recommendation(s) associated with the integration of the new set of software code into the framework.

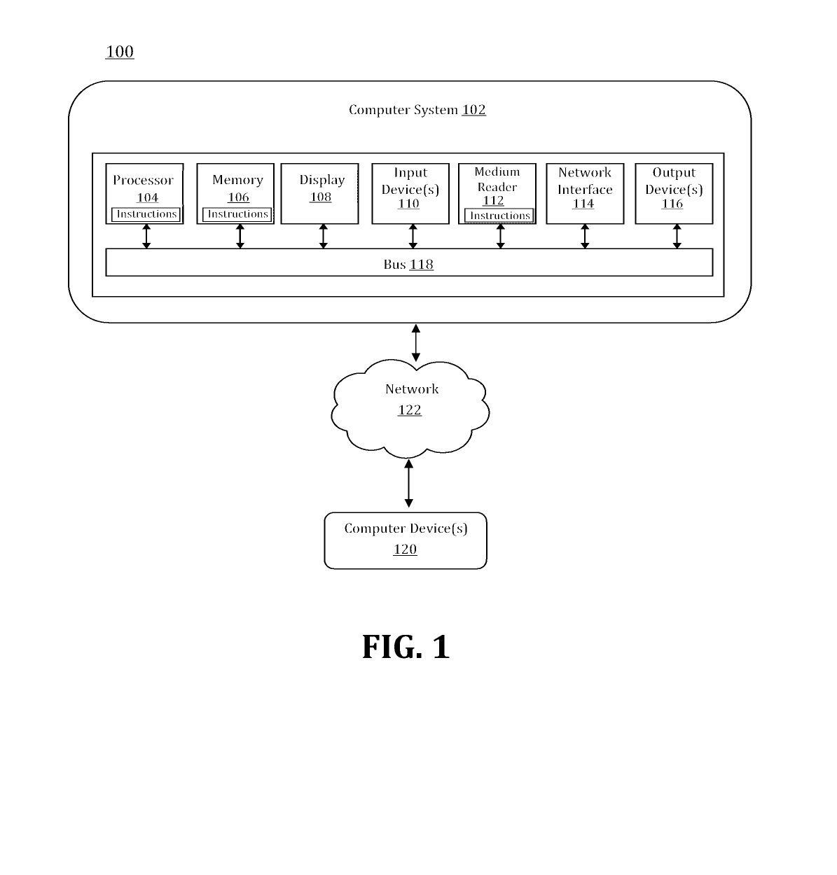

FIG. 1 is an exemplary system 100 for use in implementing a method analyzing new software code submissions in large-scale projects for adherence to an existing codebase and quantifying variations to ensure compliance with project-specific frameworks and coding standards, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain’t Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

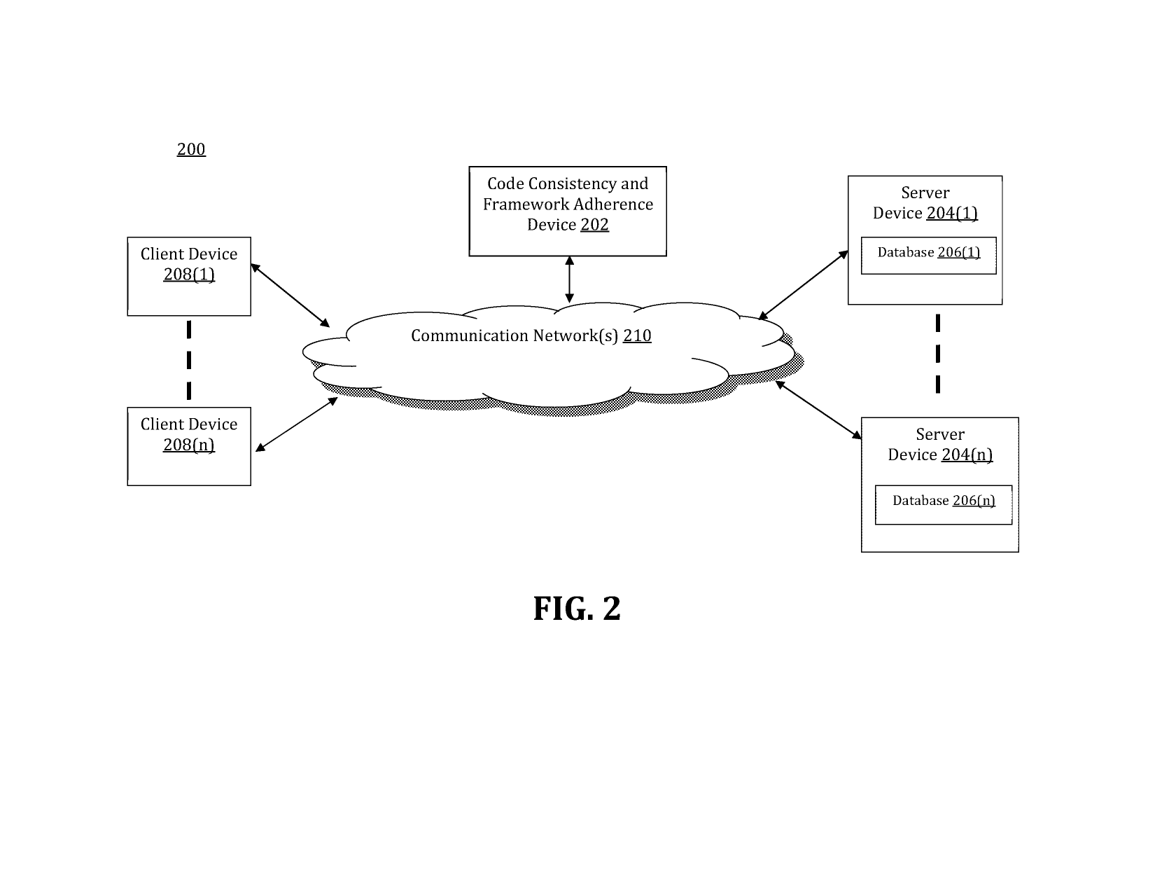

Referring to FIG. 2, a schematic of an exemplary network environment 200 for implementing a code consistency and framework adherence device (CCFAD) of the instant disclosure is illustrated.

In some embodiments, the above-described problems associated with conventional tools may be overcome by implementing a CCFAD 202 as illustrated in FIG. 2 that may be configured for implementing a method for analyzing new software code submissions in large-scale projects for adherence to an existing codebase and quantifying variations to ensure compliance with project-specific frameworks and coding standards, but the disclosure is not limited thereto.

The CCFAD 202 may have one or more computer system 102s, as described with respect to FIG. 1, which in aggregate provide the necessary functions.

The CCFAD 202 may store one or more applications that can include executable instructions that, when executed by the CCFAD 202, cause the CCFAD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CCFAD 202 itself, may be located in virtual server(s) running in a cloud-based computing environment rather than being tied to one or more specific physical network computing devices. Also, the application(s) may be running in one or more virtual machines (VMs) executing on the CCFAD 202. Additionally, in one or more embodiments of this technology, virtual machine(s) running on the CCFAD 202 may be managed or supervised by a hypervisor.

In the network environment 200 of FIG. 2, the CCFAD 202 is coupled to a plurality of server devices 204(1)-204(n) that hosts a plurality of databases 206(1)-206(n), and also to a plurality of client devices 208(1)-208(n) via communication network(s) 210. A communication interface of the CCFAD 202, such as the network interface 114 of the computer system 102 of FIG. 1, operatively couples and communicates between the CCFAD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CCFAD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CCFAD 202 may be a standalone device or integrated with one or more other devices or apparatuses, such as one or more of the server devices 204(1)-204(n), for example. In one particular example, the CCFAD 202 may be hosted by one of the server devices 204(1)-204(n), and other arrangements are also possible. Moreover, one or more of the devices of the CCFAD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CCFAD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the CCFAD 202 that may efficiently provide a platform for implementing a method for analyzing new software code submissions in large-scale projects for adherence to an existing codebase and quantifying variations to ensure compliance with project-specific frameworks and coding standards, but the disclosure is not limited thereto.

The client devices 208(1)-208(n) may run interface applications, such as standard web browsers or standalone client applications, which may provide an interface to communicate with the CCFAD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the CCFAD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the CCFAD 202, the server devices 204(1)-204(n), or the client devices 208(1)-208(n), for example, may be configured to operate as virtual instances on the same physical machine. For example, one or more of the CCFAD 202, the server devices 204(1)-204(n), or the client devices 208(1)-208(n) may operate on the same physical device rather than as separate devices communicating through communication network(s) 210. Additionally, there may be more or fewer CCFADs 202, server devices 204(1)-204(n), or client devices 208(1)-208(n) than illustrated in FIG. 2. In some embodiments, the CCFAD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

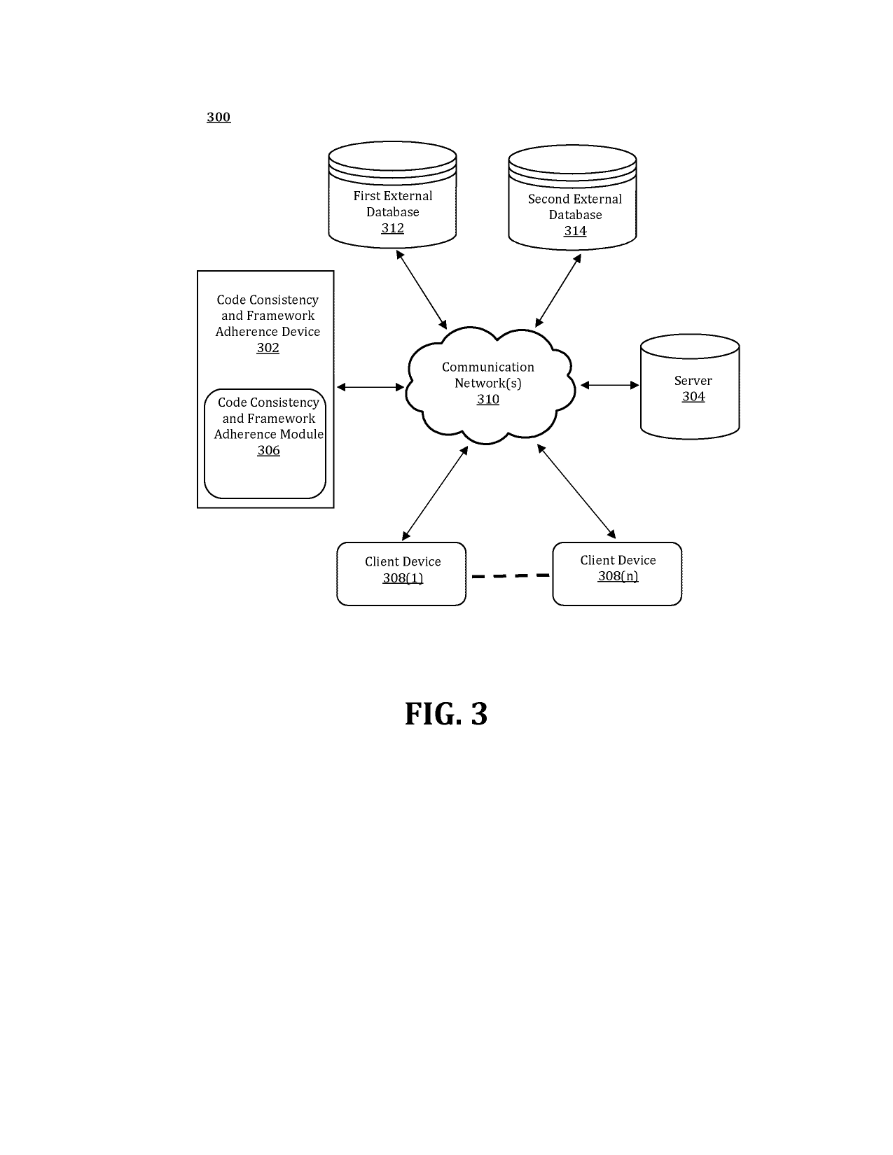

FIG. 3 illustrates a system diagram for implementing an CCFAD 302 having a code consistency and framework adherence module (CCFAM), in accordance with an embodiment.

As illustrated in FIG. 3, the system 300 may include a CCFAD 302 within which a CCFAM 306 is embedded, a server 304, a first external database 312, a second external database 314, a plurality of client devices 308(1) … 308(n), and a communication network 310.

In some embodiments, the CCFAD 302 including the CCFAM 306 may be connected to the server 304, and the database(s) 312 via the communication network 310. The CCFAD 302 may also be connected to the plurality of client devices 308(1) … 308(n) via the communication network 310, but the disclosure is not limited thereto.

In an embodiment, the CCFAD 302 is described and shown in FIG. 3 as including the CCFAM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the CCFAM 306 may be configured to receive real-time feed of data from the plurality of client devices 308(1) … 308(n) and secondary sources via the communication network 310.

As may be described below, the CCFAM 306 may be configured to: receive, from a user, a new set of software code that is intended for an integration into a framework that includes existing sets of software code; generate a first embedding of the new set of software code; compare the first embedding with a respective embedding of each respective one of the existing sets of software code, each respective embedding being stored in a vector database; determine, based on a result of the comparison, a respective degree of similarity between the first embedding and each respective embedding; quantifying, based on a result of the determination, a degree of deviation between the new set of software code and the framework; and generate, based on the results of the determination and the quantification, a framework deviation analysis report that includes textual information to describe deviation(s), issue(s), and recommendation(s) associated with the integration of the new set of software code into the framework, but the disclosure is not limited thereto.

The plurality of client devices 308(1) … 308(n) are illustrated as being in communication with the CCFAD 302. In this regard, the plurality of client devices 308(1) … 308(n) may be “clients” (e.g., customers) of the CCFAD 302 and are described herein as such. Nevertheless, it is to be known and understood that the plurality of client devices 308(1) … 308(n) need not necessarily be “clients” of the CCFAD 302, or any entity described in association therewith herein. Any additional or alternative relationship may exist between either or both of the plurality of client devices 308(1) … 308(n) and the CCFAD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) … 308(n) may communicate with the CCFAD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The CCFAD 302 may be the same or similar to the CCFAD 202 as described with respect to FIG. 2, including any features or combination of features described with respect thereto.

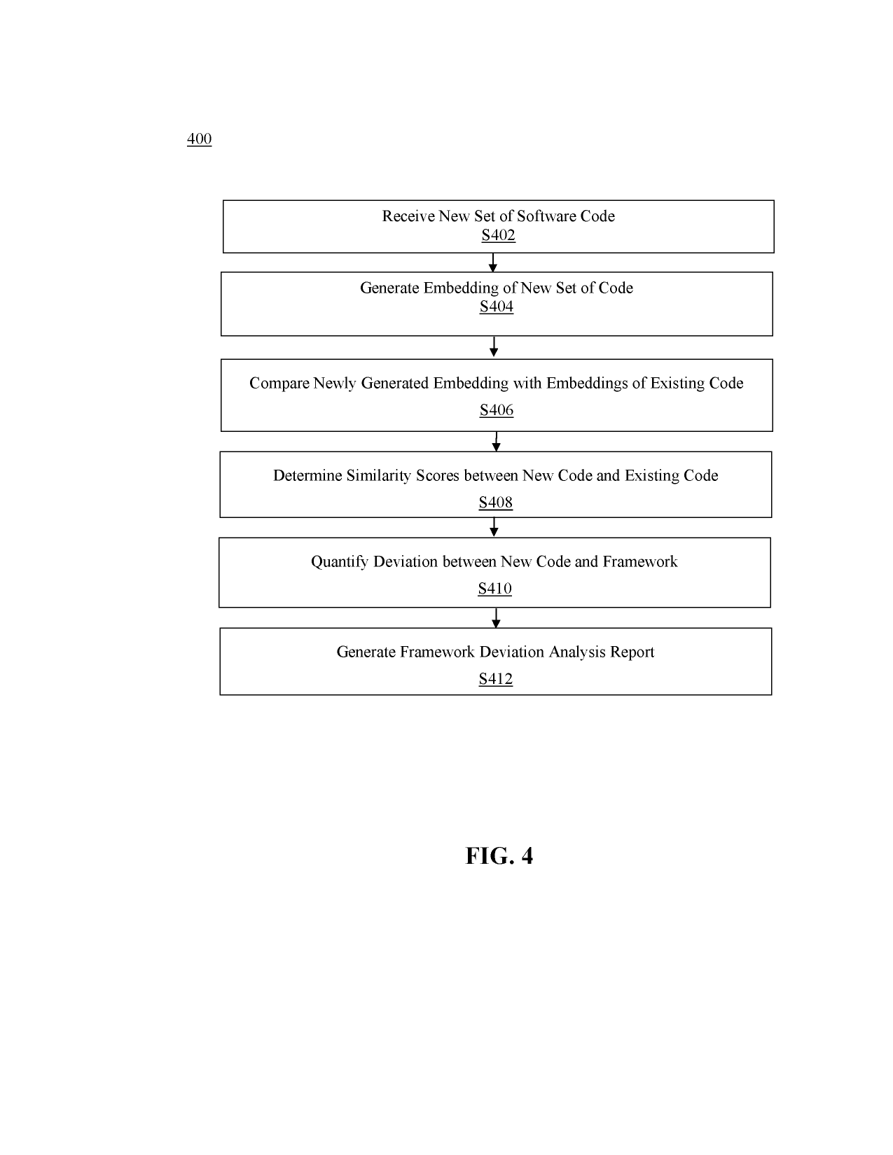

FIG. 4 illustrates an exemplary flow chart of a process 400 implemented by the CCFAM 306 of FIG. 3 for enablement of a system and a method for analyzing new software code submissions in large-scale projects for adherence to an existing codebase and quantifying variations to ensure compliance with project-specific frameworks and coding standards, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include receiving a new set of software code that is intended for integration into a framework that includes existing sets of software code. In an embodiment, the new set of software code may be received when a coder completes preparation of the new set of software code and submits the completed code into a repository that is designated therefor; or by receiving an electronic message, such as an email message, that includes the completed code or provides instructions regarding how to access the completed code. In an embodiment, the new set of software code may correspond to a software module that is developed for virtually any purpose, such as, for example, software that is designed to facilitate responding to customer queries; software that is designed to monitor computer infrastructure within a commercial or governmental entity; software that is designed for routing of communications among various participants; and/or software that is designed for any purpose that is useful in the context of requirements of an organization. In an embodiment, the framework may correspond to a large software development project that involves multiple developers, and so when a new set of software code entails an implementation of innovative ideas and/or methodologies to achieve optimal outcomes, this may result in a potential for non-compliance with established project-specific guidelines.

At step S404, the process 400 may include generating an embedding of the new set of code. In an embodiment, an embedding (also referred to herein as a “vector embedding” and/or a “vector”) may refer to an array of numbers that can be used to represent a piece of information, such as text, documents, graphical information, and/or images. In an embodiment, a word embedding may refer to a numerical representation of a word that captures a semantic meaning of the word; a graph embedding may refer to a numerical representation of a node in a graph that preserves the structural information of the graph in the context of the embedding space; and an image embedding may refer to a numerical representation of an image that captures visual aspects of the image. In an embodiment, the embedding may be generated by using a known embedding model, such as, for example, CodeBERT.

At step S406, the process 400 may include comparing the newly generated embedding with a respective embedding of each respective existing set of code. In an embodiment, each respective embedding of a corresponding existing set of code is stored in a vector database, i.e., a database that includes respective arrays of numbers that represent corresponding items of information, such as text, documents, graphical information, and/or images. In an embodiment, a respective embedding of a corresponding existing set of code may be retrieved from the vector database and then compared with the newly generated embedding by comparing respective numbers from each array that correspond positionally within the array to one another. In an embodiment, each comparison provides an indication of differences between the new set of code and each existing set of code that forms a part of the existing framework by generating the numerical differences at each respective position of the array. For example, if a vector embedding of a new set of code corresponds to the vector [3.0, 7.5, -2.0, 21.0] and the vector embedding of a particular existing set of code corresponds to the vector [5.5, -1.3, 12.0, 15.0], then the comparison may yield a vector that includes the corresponding numerical differences, i.e., [-2.5, 8.8, -14.0, 6.0]. In an embodiment, this indication of differences may correspond to various types of differences, such as, for example, semantic differences, syntactic differences, contextual differences, and/or other relevant information that relates to differences between the new set of code and the existing sets of code.

At step S408, the process may include using a result of the comparisons performed in step S406 to determine a respective degree of similarity between the newly generated embedding and each respective embedding of each respective existing set of code. In an embodiment, the degree of similarity may refer to any metric that provides a measurement of how much similarity/difference exists between the two embeddings, such as, for example, a raw numerical similarity score, a percentage that falls in a range of between 0% and 100%, and/or a textual characterization of similarity. In this aspect, the result of the determination of step S408 may include the respective degree of similarity, which may include a respective similarity score. In an embodiment, such a determination may be made by calculating similarity scores therebetween using any one or more of a predetermined cosine similarity algorithm, a predetermined Euclidean distance algorithm, and/or any other suitable algorithm that is designed to compare vector embeddings of textual content in order to generate similarity scores.

At step S410, the process 400 may include quantifying a degree of deviation between the new set of code and the framework. In an embodiment, such a quantification may entail using the similarity scores generated in step S408 to compute a percentage deviation score that falls within a range of between zero percent (i.e., 0%) and one hundred percent (i.e., 100%), where a larger percentage deviation score corresponds to a greater degree of deviation. In this aspect, the result of the quantification of step S410 may include the degree of deviation, which may include the deviation score.

At step S412, the process 400 may include using results of the preceding operations to generate a framework deviation analysis report that includes textual information to describe deviation(s), issue(s), and recommendation(s) associated with the integration of the new set of code into the framework. In an embodiment, a deviation may refer to a difference in some aspect, such as a formatting difference, a field difference such as a character length or a type such as text versus numerical, a terminological difference, and/or any other difference between the new set of code and the existing sets of code within the framework. In an embodiment, an issue may refer to any type of consequence that may arise as a result of the deviation, such as a compatibility failure between the new code and the existing sets of code, an error that is generated by the new set of code as a result of an interaction with an existing set of code, or an operational failure that may render the framework at least temporarily inoperable. In an embodiment, a recommendation may refer to an action that, if exercised in a timely manner, may prevent the issue from occurring and/or remedy the deviation, such as a recommendation to revise the new set of code in some particular way, a recommendation to delete a particular portion of the new code, or a recommendation to insert additional code that relates to a particular inconsistency. In an embodiment, the generation of the framework deviation analysis report may be performed by using a predetermined model, such as, for example, a Large Language Model (LLM), to receive the new set of code, the existing sets of code, the respective similarity scores, and the percentage deviation score as inputs, and to generate the report based on these inputs. In an embodiment, the LLM may be configured to use these inputs to identify semantic differences and/or syntactic differences between the new set of code and the existing sets of code, and to detect patterns and/or anomalies associated with the new set of code with respect to the framework.

In an embodiment, the framework deviation report includes the following: a first textual item that relates to a status of the new set of code with respect to the existing sets of software code; a second textual item that relates to the percentage deviation score, a third textual item that relates to a summary description of how the new set of code deviates from the existing sets of code, a fourth textual item that relates to a project impact to be incurred by the integration of the new set of code into the framework, and a fifth textual item that relates to a recommendation for additional action to be taken as a result of the integration. The project impact may include first information that relates to a potential code refactoring requirement with respect to at least one of the existing sets of code, second information that relates to a consistency between the new set of software code and the framework, and third information that relates to dependency management as between the new set of software code and the framework.

In an embodiment, the CCFAM 306 of FIG. 3 implements an innovative, language-neutral tool designed to analyze new code submissions in large-scale software projects. In an embodiment, this tool ensures compliance with project-specific frameworks and coding standards by quantifying variations from the existing codebase. In an embodiment, the tool may be implemented as an Integrated Development Environment (IDE) plugin that facilitates pre-commit project-specific compliance checks, flags deviations, and suggests best practices.

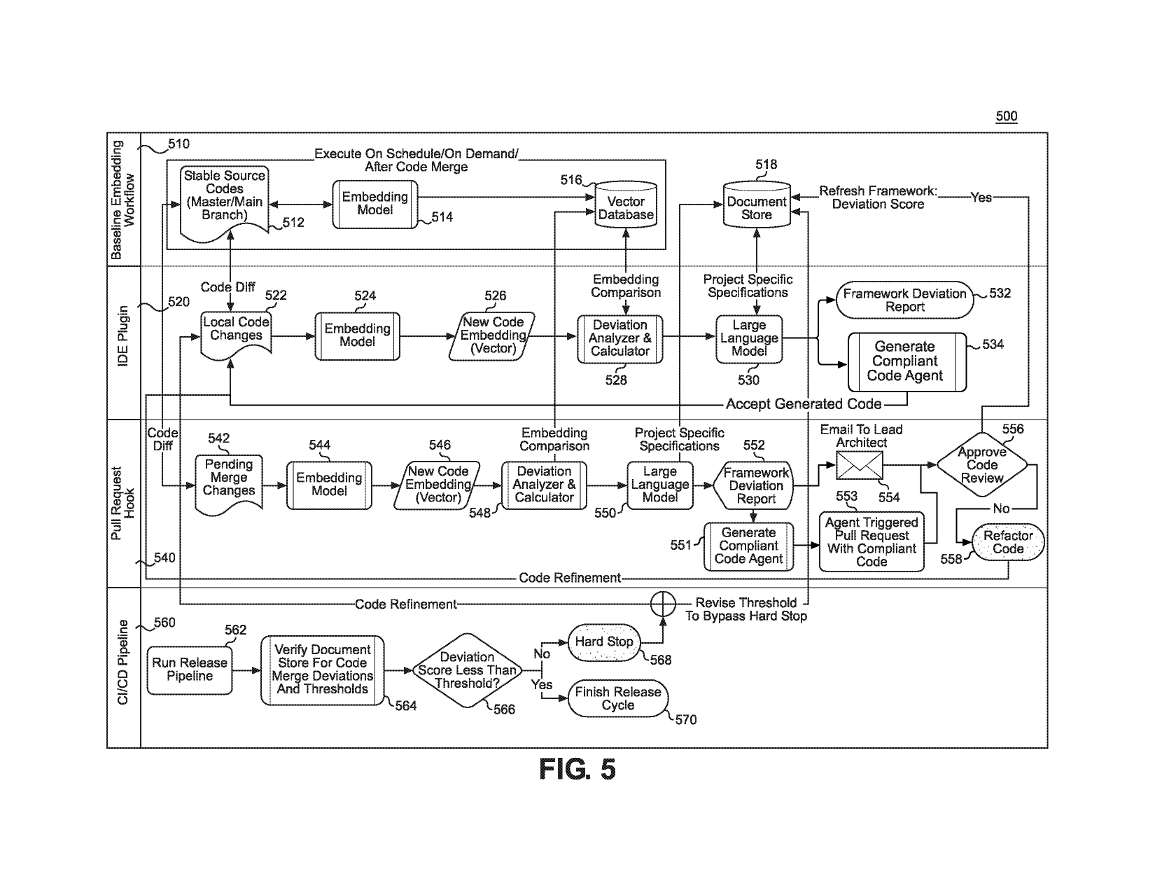

FIG. 5 illustrates a data flow diagram 500 for a system for analyzing new software code submissions in large-scale projects for adherence to an existing codebase and quantifying variations to ensure compliance with project-specific frameworks and coding standards, in accordance with an embodiment. As shown in FIG. 5, a baseline embedding workflow 510 may include a database 512 that stores a set of stable source code modules that are part of a framework for a software development project. Each stable source code module is provided as an input to an embedding model 514, which generates a respective embedding thereof and then stores the respective embedding in vector database 516. The baseline embedding workflow 510 may also include a document store 518 that is configured to store various types of information, such as project-specific specifications and other suitable types of information that relate to the framework of the software development project.

Referring again to FIG. 5, an IDE plugin section 520 may include a workspace 522 that stores local code changes, such as, for example, a new set of code that is being introduced (see also FIG. 4, step S402) for integration into the framework. Similarly as in step S404 of FIG. 4, the new code and/or local code changes may be provided as input(s) to an embedding model 524, which may be equivalent or similar to the embedding model 514, in order to generate a new code embedding vector at 526. The new code embedding vector may be provided to a deviation analysis and calculator 528, which may be configured to access the vector database 516 in order to perform respective comparisons between the new code embedding vector and the embeddings stored in the vector database 516 (see also steps S406 and S408 of FIG. 4). Similarly as in step S410 of FIG. 4, a result of these comparisons may be provided as input to a Large Language Model (LLM) 530, which may also access information stored in the document store 518 in order to generate a framework deviation report at 532 (see also step S412 of FIG. 4). The LLM 530 may also provide input to a Generate Compliant Code Agent 534 that may automatically generate compliant code to address any detected framework deviations in the local environment. After the compliant code is generated, the user may be provided with an option to accept or reject the suggested changes before proceeding. When the user accepts the suggested changes, then the accepted generated code may be forwarded to the local code changes workspace 522.

Referring again to FIG. 5, a pull request hook section 540 may include a database 542 that stores pending merge changes, such as, for example, a new set of code that is being introduced (see also FIG. 4, step S402) for integration into the framework. Similarly as in step S404 of FIG. 4, the pending merge changes may be provided as input(s) to an embedding model 544, which may be equivalent or similar to the embedding model 514, in order to generate a new code embedding vector at 546. The new code embedding vector may be provided to a deviation analysis and calculator 548, which may be equivalent or similar to the deviation analysis and calculator 528, and which may be configured to access the vector database 516 in order to perform respective comparisons between the new code embedding vector and the embeddings stored in the vector database 516 (see also steps S406 and S408 of FIG. 4). Similarly as in step S410 of FIG. 4, a result of these comparisons may be provided as input to a Large Language Model (LLM) 550, which may be equivalent or similar to the LLM 530, and which may also access information stored in the document store 518 in order to generate a framework deviation report at 552 (see also step S412 of FIG. 4). Then, at 554, the framework deviation report may be sent via email to an interested party, such as, for example, a lead architect of the software development project, in order to provide notification of the information included in the report, and to afford an opportunity for review. At 556, a determination may be made regarding whether to approve the new code, and when the new code is approved, the new code may be merged with the existing code, and then a deviation score that is based on the merged code is computed and provided to the document store 518 for storage therein, and a new set of baseline embeddings is generated in order to reflect the merge. When the new code is not approved, the new code may be inputted into a refactor code module 558 in order to afford an opportunity to perform a code refinement operation and then provide the refined code into the local code changes workspace 522 for further processing. The LLM 550 may also provide input to a Generate Compliant Code Agent 551 that may automatically generate compliant code in the context of a pull request (PR) workflow. Upon submission of a PR, the Generate Compliant Code Agent 551 may analyze the new changes for framework deviations and then generate a separate PR containing the compliant code suggestions, which may then be forwarded at 553 to an agent-triggered pull request with compliant code module. The approver/reviewer may be provided with an option to accept or reject the AI-generated PR, thereby allowing for transparent review and decision-making. This dual-PR approach ensures that both the original user-submitted changes and the AI-generated compliance suggestions are clearly visible and can be independently evaluated.

Referring again to FIG. 5, a continuous integration / continuous development (CI/CD) pipeline section 560 may include a run release pipeline module 562 that is configured to continuously update the system with respect to ongoing integrations of new code into the framework. At 564, a verification of the document store 518 for code merge deviations and thresholds is performed with respect to the results of introducing new code. At 566, a determination is made regarding whether a particular deviation score is less than a predetermined threshold, and when the particular deviation score is not less than the threshold, then a hard stop 568 may be implemented in order to avoid undesired impacts to the framework. When the particular deviation score is less than the threshold, then a finish release cycle operation 570 may be performed in order to complete the integration of the new code into the framework. In an embodiment, when the hard stop is implemented at 568, a project administrator may determine whether to adjust the predetermined threshold, such as, for example, when the relatively high particular deviation score is justifiable, or to refine or refactor the new code in order to make necessary changes to reduce the particular deviation score, similarly as at refactor code module 558.

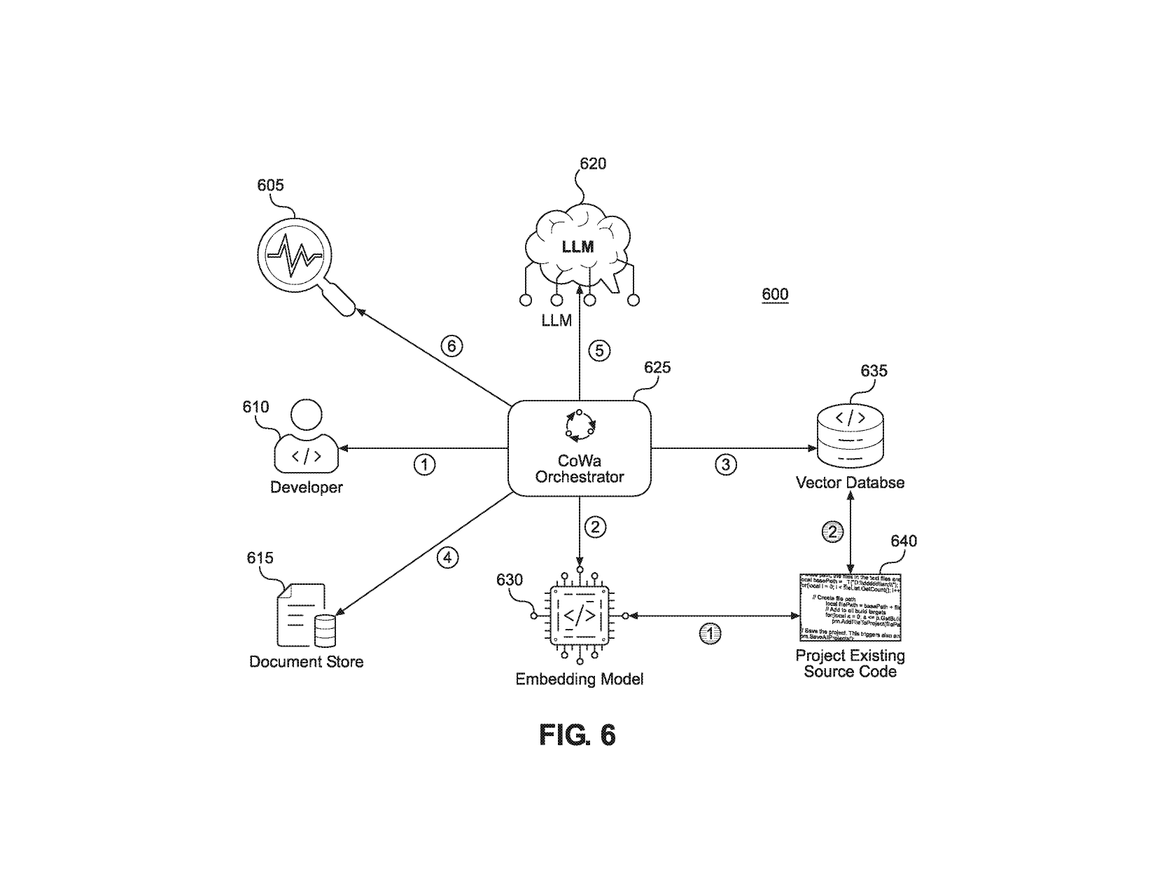

FIG. 6 illustrates an architecture diagram 600 of a system for analyzing new software code submissions in large-scale projects for adherence to an existing codebase and quantifying variations to ensure compliance with project-specific frameworks and coding standards, in accordance with an embodiment.

As shown in FIG. 6, the architecture of the system may involve generating embeddings of the existing project source code 640 using an embedding model 630, such as, for example, CodeBERT. In an embodiment, these embeddings may be stored in a vector database 635, such as, for example, ChromaDB.

Referring again to FIG. 6, when a developer 610 writes new code (see also FIG. 4, step S402), a ComplianceWatch (hereinafter “CoWa”) orchestrator module 625 may identify the new code non-committed code and generate an embedding vector for the new code using the embedding model 630, similarly as in step S404 of FIG. 4. This newly generated embedding vector may then be used to query the vector database 635 to find relevant information, similarly as in steps S406, S408, and S410 of FIG. 4. The information may also be enhanced by applying project-specific rules that are accessible via document store 615.

Referring again to FIG. 6, in an embodiment, the query results may be sent to a large language model (LLM) 620, such as, for example, GPT-4, which processes the data to generate a detailed deviation analysis report, similarly as in step S412 of FIG. 4. This portion of the process may involve several aspects, including the following: 1) Contextual Understanding: The LLM 620 may comprehend the context of both the existing and new code, identifying semantic and syntactic differences. 2) Pattern Recognition: The LLM 620 may detect patterns and anomalies in the new code compared to the existing codebase. 3) Natural Language Generation: The LLM 620 may produce a human-readable report that details deviations, including potential issues and suggestions for compliance with project-specific frameworks and coding standards. After report generation, the report may be sent to interested parties 605 for review thereof, thereby providing actionable insights to ensure project framework compliance.

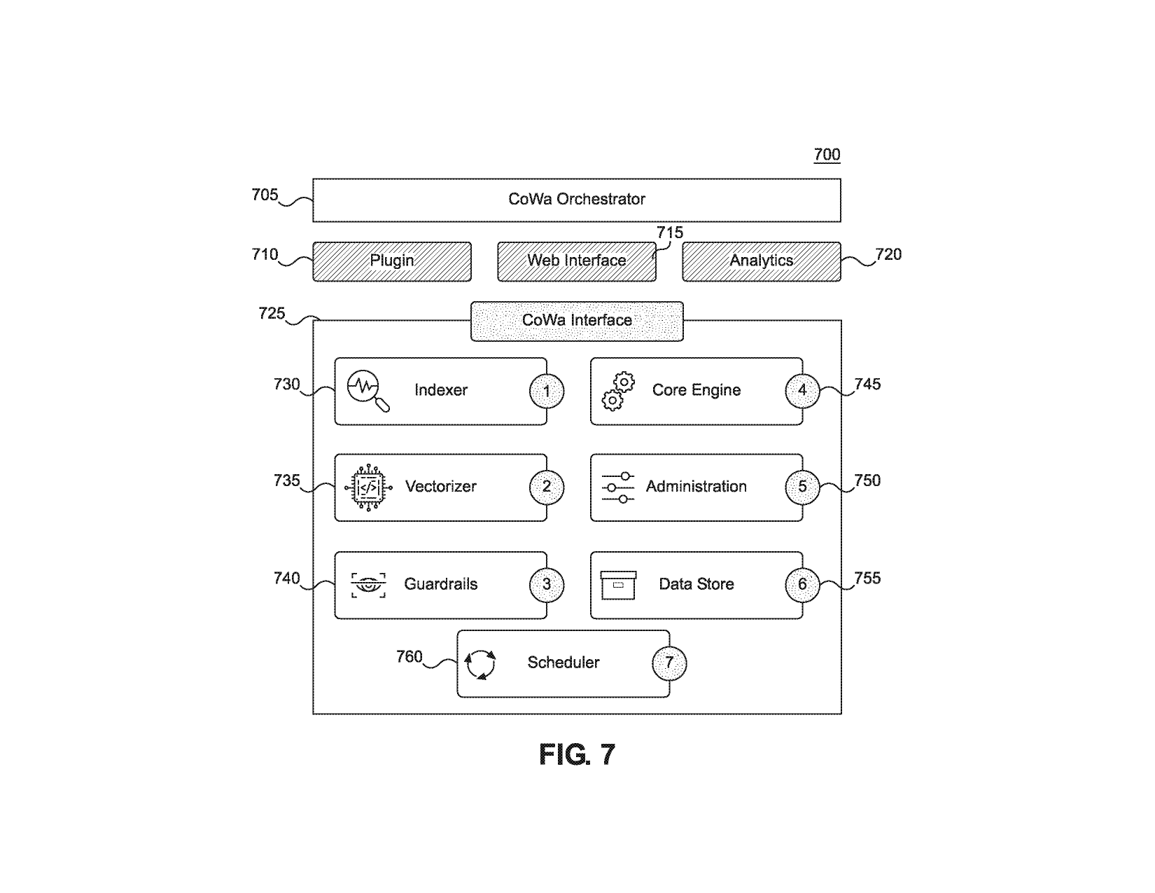

FIG. 7 illustrates a system orchestrator diagram 700 that shows a set of functions that are performed in a system for analyzing new software code submissions in large-scale projects for adherence to an existing codebase and quantifying variations to ensure compliance with project-specific frameworks and coding standards, in accordance with an embodiment. As shown in FIG. 7, CoWa orchestrator 705 includes a plugin module 710 that is configured to receive plugin applications, such as IDE plugin 520; a web interface module 715 that is configured to interface with the internet; and an analytics module 720 that is configured to execute analytical functions, such as, for example, comparing newly generated embeddings with embeddings of existing code, similarly as in step S406 of FIG. 4, determining similarity scores, as in step S408 of FIG. 4, and/or quantifying deviations between new code modules and an existing code framework, as in step S410 of FIG. 4.

Referring again to FIG. 7, a CoWa interface 725 may include several types of interfaces. An indexer 730 may be configured to detect a type of programming language that is used for a particular software code module, and to parse and load source codes as documents with an optimal chunk size and chunk overlap. In an embodiment, the indexer 730 may be configured to utilize advance text parsing algorithms to break down source code into manageable chunks, and to implement chunk overlap strategies to ensure context continuity across document boundaries. In an embodiment, the indexer 730 may support various programming languages and file formats in order to ensure comprehensive indexing.

Referring again to FIG. 7, a vectorizer 735 may be configured to generate embeddings of source codes using embedding models that are specifically designed, trained, and/or fine-tuned for code-related tasks. In an embodiment, the vectorizer 735 converts code into high-dimensional vectors that capture both syntactic and semantic information. In an embodiment, the vectorizer 735 is optimized for performance to handle large-scale codebases efficiently.

Referring again to FIG. 7, guardrails 740 are configured to ensure that LLM outputs are accurate, reliable, and aligned with user expectations and ethical guidelines. In an embodiment, the guardrails 740 implement validation and verification mechanisms to check the accuracy of LLM-generated outputs, and enforce ethical guidelines and user-defined constraints to prevent biased or inappropriate content. In an embodiment, the guardrails 740 utilize feedback loops to continuously improve the reliability and alignment of LLM outputs.

Referring again to FIG. 7, core engine 745 coordinates various components, including project-specific checks. In an embodiment, the core engine 745 acts as a central orchestrator, managing workflows between different services, and integrating with project-specific compliance checks to ensure adherence to coding standards and frameworks. In an embodiment, the core engine 745 utilizes a microservices architecture for scalability and modularity.

Referring again to FIG. 7, an administration module 750 provides a web interface to view and manage project-specific settings. In an embodiment, the administration module 750 enables administrators to adjust framework deviation thresholds in order to ensure that the system aligns with project-specific requirements, and also enables the configuration of acceptable project frameworks and standards, thereby ensuring compliance with organizational guidelines.

Referring again to FIG. 7, a data store 755 provides access to the document store, i.e., document store 518 and/or document store 615, where project-specific templates and configurations are stored. In an embodiment, the data store 755 ensures secure access and retrieval of project-specific templates and configurations, and supports versioning and auditing to track changes and maintain data integrity.

Referring again to FIG. 7, a scheduler 760 implements advanced scheduling algorithms to optimize a timing and frequency of embedding generation tasks. In an embodiment, the scheduler 760 supports both cron-like scheduling for periodic tasks and event-driven scheduling for on-demand tasks.

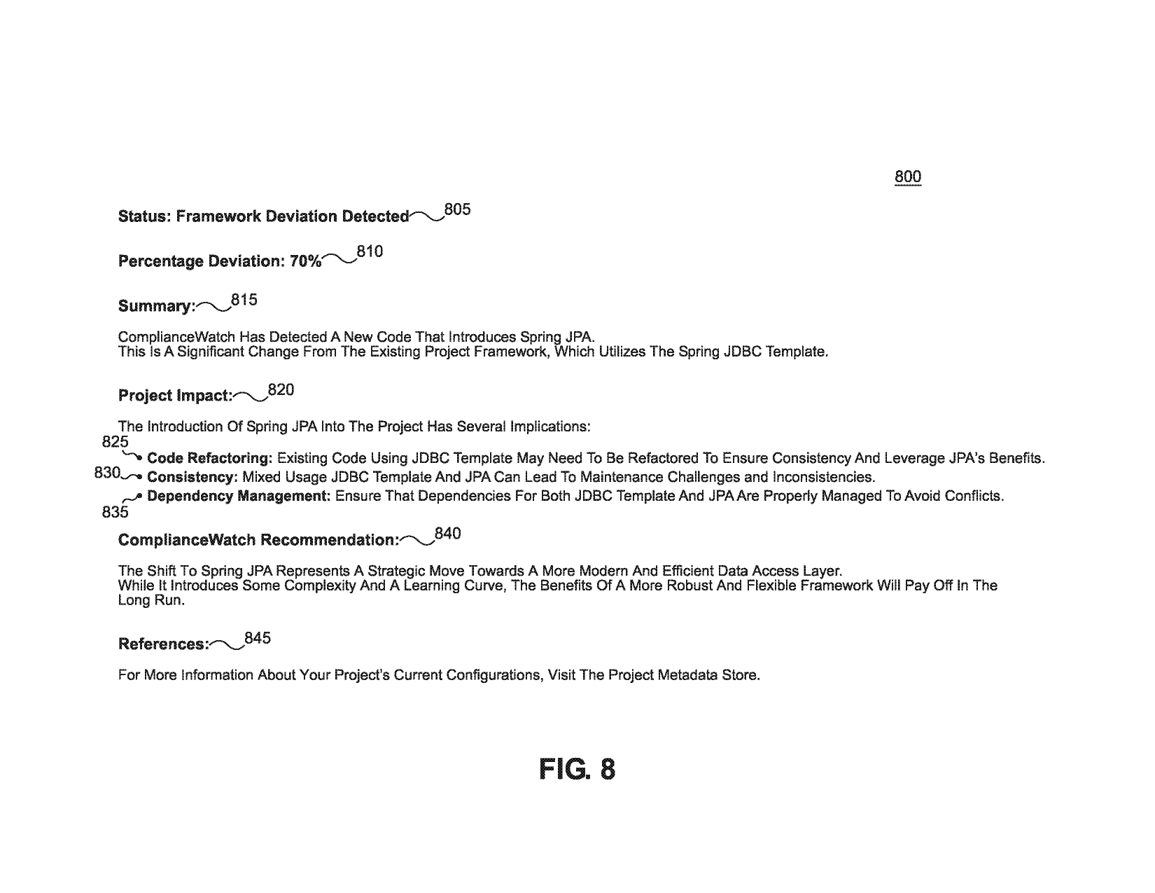

FIG. 8 illustrates an example screenshot generated by a system for analyzing new software code submissions in large-scale projects for adherence to an existing codebase and quantifying variations to ensure compliance with project-specific frameworks and coding standards, in accordance with an embodiment. In particular, screenshot shows an example of a framework deviation analysis report 800, in accordance with an embodiment.

As shown in FIG. 8, a framework deviation analysis report 800 may include a first textual item that relates to a status 805 of the new software code with respect to the existing sets of software code. For example, the status 805 of the new code may be “Framework deviation detected” in order to indicate that a deviation from the framework has been detected. The framework deviation analysis report 800 may also include a second textual item that relates to the percentage deviation score 810. For example, the percentage deviation score 810 may be equal to 70%. The framework deviation analysis report 800 may also include a third textual item that relates to a summary description 815 of how the new code deviates from the existing code. For example, the summary description 815 may indicate that the “new code introduces [a particular type of template]” and that “This is a significant change from the existing project framework, which utilizes [a different type of] Template.”

Referring again to FIG. 8, the framework deviation analysis report 800 may also include a fourth textual item that relates to a project impact 820 to be incurred by the integration of the new code into the framework. In an embodiment, the project impact 820 may include first information that relates to a potential code refactoring requirement 825 with respect to at least one of the existing sets of code, second information that relates to a consistency 830 between the new code and the framework, and third information that relates to dependency management 835 as between the new code and the framework.

Referring again to FIG. 8, the framework deviation analysis report 800 may also include a sixth textual item that relates to a recommendation 840 for additional action to be taken as a result of the integration of the new code into the framework. The framework deviation analysis report 800 may also include a references item 845 to notify a reader about where and/or how to access additional information that may be useful to the reader.

In some embodiments as disclosed above in FIGS. 1-8, technical improvements effected by the instant disclosure may include a platform for implementing a code consistency and framework adherence module configured for enablement of analyzing new software code submissions in large-scale projects for adherence to an existing codebase and quantifying variations to ensure compliance with project-specific frameworks and coding standards, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for integrating software code into an existing codebase, the method being implemented by at least one processor, the method comprising:
receiving, from a user, a first set of software code that is intended for an integration into a first framework that includes a plurality of existing sets of software code;
generating a first embedding of the first set of software code;
comparing the first embedding with a respective embedding of each respective one of the plurality of existing sets of software code, each respective embedding being stored in a vector database;
determining, based on a result of the comparing, a respective degree of similarity between the first embedding and each respective embedding;
quantifying, based on a result of the determining, a degree of deviation between the first set of software code and the first framework; and
generating, based on the result of the determining and a result of the quantifying, a framework deviation analysis report that includes textual information to describe at least one from among a difference, an issue, and a recommendation associated with the integration into the first framework.

2. The method of claim 1, wherein the determining of the respective degree of similarity comprises using at least one from among a predetermined cosine similarity algorithm and a predetermined Euclidean distance algorithm to calculate a respective similarity score.

3. The method of claim 2, wherein the quantifying comprises using each respective similarity score to compute a percentage deviation score.

4. The method of claim 3, wherein the generating of the framework deviation report is performed by using a predetermined large language model (LLM) that is configured to:
receive the first set of software code, the plurality of existing sets of software code, the respective similarity scores, and the percentage deviation score as inputs;
identify semantic differences and syntactic differences between the first set of software code and the plurality of existing sets of software code;
detect at least one from among a pattern and an anomaly associated with the first set of software code with respect to the plurality of existing sets of software code; and
generate the framework deviation report based on the identified semantic differences, the identified syntactic differences, and the detected at least one from among the pattern and the anomaly.

5. The method of claim 3, wherein the framework deviation report includes a first textual item that relates to a status of the first set of software code with respect to the plurality of existing sets of software code, a second textual item that relates to the percentage deviation score, a third textual item that relates to a summary description of how the first set of software code deviates from the plurality of existing sets of software code, a fourth textual item that relates to a project impact to be incurred by the integration of the first set of software code into the first framework, and a fifth textual item that relates to a recommendation for additional action to be taken as a result of the integration.

6. The method of claim 5, wherein the project impact includes first information that relates to a potential code refactoring requirement with respect to at least one of the plurality of existing sets of software code, second information that relates to a consistency between the first set of software code and the first framework, and third information that relates to dependency management as between the first set of software code and the first framework.

7. The method of claim 1, wherein the difference includes at least one from among a formatting difference between the first set of software code and the first framework, a field character length difference between the first set of software code and the first framework, a field type difference between the first set of software code and the first framework, and a terminological difference between the first set of software code and the first framework.

8. The method of claim 1, wherein the issue includes at least one from among a compatibility failure between the first set of software code and the first framework, an error that is generated by the first set of software code as a result of an interaction with the first framework, and an operational failure that renders the first framework at least temporarily inoperable.

9. The method of claim 1, wherein the recommendation includes at least one from among a first recommendation to revise the first set of software code in a particular way, a second recommendation to delete a particular portion of the first set of software code, and a third recommendation to insert additional code that relates to a particular inconsistency.

10. A computing apparatus for integrating software code into an existing codebase, the computing apparatus comprising:
a processor;
a memory; and
a communication interface coupled to each of the processor and the memory,
wherein the processor is configured to:
receive, from a user via the communication interface, a first set of software code that is intended for an integration into a first framework that includes a plurality of existing sets of software code;
generate a first embedding of the first set of software code;
compare the first embedding with a respective embedding of each respective one of the plurality of existing sets of software code, each respective embedding being stored in a vector database;
determine, based on a result of the comparison, a respective degree of similarity between the first embedding and each respective embedding;
quantify, based on a result of the determination, a degree of deviation between the first set of software code and the first framework; and
generate, based on the result of the determination and a result of the quantification, a framework deviation analysis report that includes textual information to describe at least one from among a difference, an issue, and a recommendation associated with the integration into the first framework.

11. The computing apparatus of claim 10, wherein the processor is further configured to determine the respective degree of similarity by using at least one from among a predetermined cosine similarity algorithm and a predetermined Euclidean distance algorithm to calculate a respective similarity score.

12. The computing apparatus of claim 11, wherein the processor is further configured to quantify the degree of deviation by using each respective similarity score to compute a percentage deviation score.

13. The computing apparatus of claim 12, wherein the processor is further configured to generate the framework deviation report by using a predetermined large language model (LLM) that is configured to:
receive the first set of software code, the plurality of existing sets of software code, the respective similarity scores, and the percentage deviation score as inputs;
identify semantic differences and syntactic differences between the first set of software code and the plurality of existing sets of software code;
detect at least one from among a pattern and an anomaly associated with the first set of software code with respect to the plurality of existing sets of software code; and
generate the framework deviation report based on the identified semantic differences, the identified syntactic differences, and the detected at least one from among the pattern and the anomaly.

14. The computing apparatus of claim 12, wherein the framework deviation report includes a first textual item that relates to a status of the first set of software code with respect to the plurality of existing sets of software code, a second textual item that relates to the percentage deviation score, a third textual item that relates to a summary description of how the first set of software code deviates from the plurality of existing sets of software code, a fourth textual item that relates to a project impact to be incurred by the integration of the first set of software code into the first framework, and a fifth textual item that relates to a recommendation for additional action to be taken as a result of the integration.

15. The computing apparatus of claim 14, wherein the project impact includes first information that relates to a potential code refactoring requirement with respect to at least one of the plurality of existing sets of software code, second information that relates to a consistency between the first set of software code and the first framework, and third information that relates to dependency management as between the first set of software code and the first framework.

16. The computing apparatus of claim 10, wherein the difference includes at least one from among a formatting difference between the first set of software code and the first framework, a field character length difference between the first set of software code and the first framework, a field type difference between the first set of software code and the first framework, and a terminological difference between the first set of software code and the first framework.

17. The computing apparatus of claim 10, wherein the issue includes at least one from among a compatibility failure between the first set of software code and the first framework, an error that is generated by the first set of software code as a result of an interaction with the first framework, and an operational failure that renders the first framework at least temporarily inoperable.

18. The computing apparatus of claim 10, wherein the recommendation includes at least one from among a first recommendation to revise the first set of software code in a particular way, a second recommendation to delete a particular portion of the first set of software code, and a third recommendation to insert additional code that relates to a particular inconsistency.

19. A non-transitory computer readable storage medium storing instructions for integrating software code into an existing codebase, the storage medium comprising executable code which, when executed by a processor, causes the processor to:
receive, from a user, a first set of software code that is intended for an integration into a first framework that includes a plurality of existing sets of software code;
generate a first embedding of the first set of software code;
compare the first embedding with a respective embedding of each respective one of the plurality of existing sets of software code, each respective embedding being stored in a vector database;
determine, based on a result of the comparison, a respective degree of similarity between the first embedding and each respective embedding;
quantify, based on a result of the determination, a degree of deviation between the first set of software code and the first framework; and
generate, based on the result of the determination and a result of the quantification, a framework deviation analysis report that includes textual information to describe at least one from among a difference, an issue, and a recommendation associated with the integration into the first framework.

20. The storage medium of claim 19, wherein when executed, the executable code further causes the processor to determine the respective degree of similarity by using at least one from among a predetermined cosine similarity algorithm and a predetermined Euclidean distance algorithm to calculate a respective similarity score.
